(19) United States
(12) Patent Application Publication
(10) Pub. No.: US 2018/0168201 A1
(43) Pub. Date: Jun. 21, 2018

(54) Load Basket With Removable End Cap

(71) Applicant: Avure Technologies Incorporated, Middletown, OH (US)

(72) Inventors: Magnus Malmberg, Mjolby (SE); Limin Zhang, Mason, OH (US); Joakim Brangel, Vasteras (SE)

(21) Appl. No.: 15/380,563

(22) Filed: Dec. 15, 2016

(51) Int. Cl. A23L 3/015; B65D 43/02; B65D 45/16

(52) U.S. Cl. CPC A23L 3/015; A23V 2002/00; B65D 45/16; B65D 43/0225

(57) ABSTRACT

A basket for high pressure processing includes a body having first and second ends and a sidewall extending therebetween. The body defines an interior space and the first end includes a first opening for providing access to the interior space. The basket includes a first end cap removably attachable to the body at the first end for at least partially covering the first opening by positioning the first end cap adjacent the first opening and rotating the first end cap in place.

### TECHNICAL FIELD

This invention generally relates to a load basket for high pressure processing and, in particular a load basket with a removable end cap.

### BACKGROUND

High pressure food processing is a post-packaging treatment that eradicates food pathogens and spoilage organisms in food products. Typically, the food product is packaged in a flexible container, such as a pouch, a bottle, or a plastic sealed tray, and is loaded into a container, commonly referred to as a load basket. The basket is then placed into a high pressure food processing chamber that gets filled with a pressure-transmitting fluid, such as water or other hydraulic fluid. The hydraulic fluid in the chamber is then pressurized, and this pressure is transmitted through the flexible container and into the food product itself. The desired pressure level is typically below 95,700 psi. The pressure is applied for a specific time, such as between 30 seconds and 30 minutes, after which the fluid in the chamber is decompressed. The load basket with processed food product is then taken out of the chamber and the processed food is taken out from the load basket and stored or distributed in a conventional manner. In some cases, the load basket may be rotated to facilitate unloading of the processed food. Because the pressure is transmitted isostatically (in all directions simultaneously), food retains its shape, even at extreme pressures. This process can be used for both solid and liquid food products.

A typical basket includes a cylindrical body having first and second fixed end covers, a sidewall extending therebetween, and at least one top opening in the sidewall, through which the packaged food products may be inserted into and removed from the basket. However, this configuration may require that the basket be positioned in a particular horizontal orientation wherein the opening faces upwardly in order to effectively load packaged food products into the basket. This configuration may also require that the basket remain in this orientation while being transported and placed into the high pressure chamber in order to avoid packaged food product spilling out of the basket through the opening. And, this configuration may not be suitable for unloading the packaged food product with the basket in a vertical or inclined orientation, as packaged food product may tend to accumulate near the lower fixed end cover and thus remain in the basket until it is manually removed. These and other disadvantages may result in the loading and unloading processes being time consuming and labor intensive.

It would therefore be desirable to provide an improved load basket for high pressure food processing and having at least one removable end cap.

### SUMMARY

In one embodiment, a basket for high pressure processing includes a body having first and second ends and a sidewall extending therebetween. The body defines an interior space and the first end includes a first opening for providing access to the interior space. The basket includes a first end cap removably attachable to the body at the first end for at least partially covering the first opening by positioning the first end cap adjacent the first opening and rotating the first end cap in place. In one embodiment, the first end cap and the first end are formed with interlocking features operable to engage each other for attaching the first end cap to the body. The interlocking features may each have a low profile to minimize obstruction of items passing through the first opening.

In another embodiment, the first end includes at least first and second locking lips and the first end cap includes at least one outer flange and at least first and second engagement tabs spaced apart from the outer flange to define at least first and second channels for receiving the first and second locking lips. The locking lips may frictionally engage at least one of the outer flange or engagement tabs. In addition or alternatively, at least one of the channels has at least one width and at least one of the locking lips has at least one thickness approximately equal to the at least one width. In one embodiment, at least one of the channels has at least one depth and at least one of the locking lips has at least one width approximately equal to the at least one depth. In addition or alternatively, at least one of the channels has a first arc length and at least one of the locking lips has a second arc length approximately equal to the first arc length. In one embodiment, at least one of the locking lips has a low profile. For example, at least one of the locking lips may have a width of between approximately 1/16 of an inch and approximately 2 inches.

In one embodiment, the basket further includes a second end cap removably attachable to the body at the second end for at least partially covering a second opening of the second end by positioning the second end cap adjacent the second opening and rotating the second end cap in place.

In one embodiment, the first end cap includes a plurality of fluid passage holes. In addition or alternatively, the basket may further include at least one top opening in the sidewall and a reinforcing portion between the first opening and the at least one top opening.

In another embodiment, a basket for high pressure processing includes a body having first and second ends and a sidewall extending therebetween. The body defines an interior space and the first end includes a first opening for providing access to the interior space. The opening is at least partially defined by first and second locking lips and first and second recesses. The basket further includes a first end cap including at least one outer flange and at least first and second engagement tabs spaced apart from the outer flange to define at least first and second channels. The first and second engagement tabs are received in the first and second recesses, respectively, in a first orientation of the first end cap relative to the body. The first and second locking lips are received in the first and second channels, respectively, in a second orientation of the first end cap relative to the body, such that the first end cap is removably attachable to the body at the first end. The first end cap may be rotatable between the first and second orientations in both a clockwise and counterclockwise direction.

In another embodiment, a method of limiting access to an interior space of a basket for high pressure processing, wherein the basket includes a body including first and second ends and a sidewall extending therebetween, the body defining the interior space and the first end including a first opening for providing access to the interior space, includes positioning a first end cap adjacent the first opening and rotating the first end cap in place to removably attach the first end cap to the body. Positioning the first end cap adjacent the first opening may include axially aligning the first end cap and the body.

In one embodiment wherein the first end includes at least first and second locking lips and first and second recesses, and the first end cap includes at least one outer flange and at least first and second engagement tabs spaced apart from the outer flange to define at least first and second channels, positioning the first end cap adjacent the first opening includes positioning the first and second engagement tabs within the first and second recesses, respectively. Rotating the first end cap in place may include rotating the first end cap from a first orientation wherein the first and second engagement tabs are received in the first and second recesses, respectively, to a second orientation wherein the first and second locking lips are received in the first and second channels, respectively. The method may further include rotating the first end cap in place from the second orientation to the first orientation.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a perspective view of an exemplary load basket with a removable end cap.

FIG. 2 is a perspective view of the basket in FIG. 1, illustrating the end cap being moved toward an opening of the basket.

FIG. 3A is a cross sectional view of the basket in FIG. 2, taken along line 3A-3A.

FIG. 3B is a cross sectional view similar to FIG. 3A, illustrating the end cap in an unlocked position.

FIG. 3C is a cross sectional view similar to FIG. 3B, illustrating the end cap in a locked position.

FIG. 4A is a front elevation view of the basket in FIG. 1 in partial cross-section, illustrating the end cap being moved toward an opening of the basket.

FIG. 4B is a front elevation view similar to FIG. 4A, illustrating the end cap in an unlocked position.

FIG. 4C is a front elevation view similar to FIG. 4B, illustrating the end cap in a locked position.

FIG. 5A is a front elevation view of an alternative basket in partial cross-section, illustrating an end cap being moved toward an opening of the basket.

FIG. 5B is a front elevation view similar to FIG. 5A, illustrating the end cap in an unlocked position.

FIG. 5C is a front elevation view similar to FIG. 5B, illustrating the end cap in a locked position.

### DETAILED DESCRIPTION

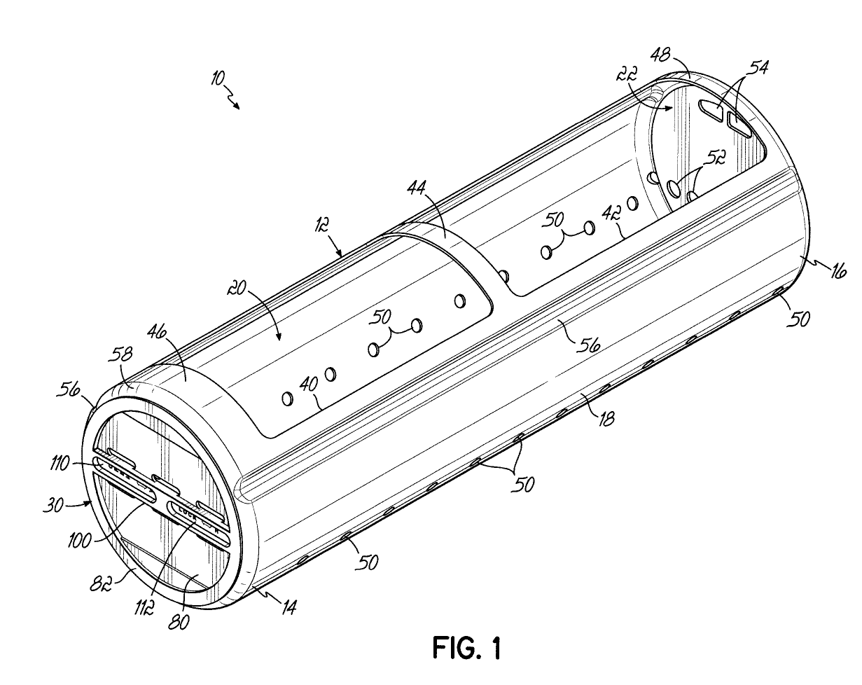

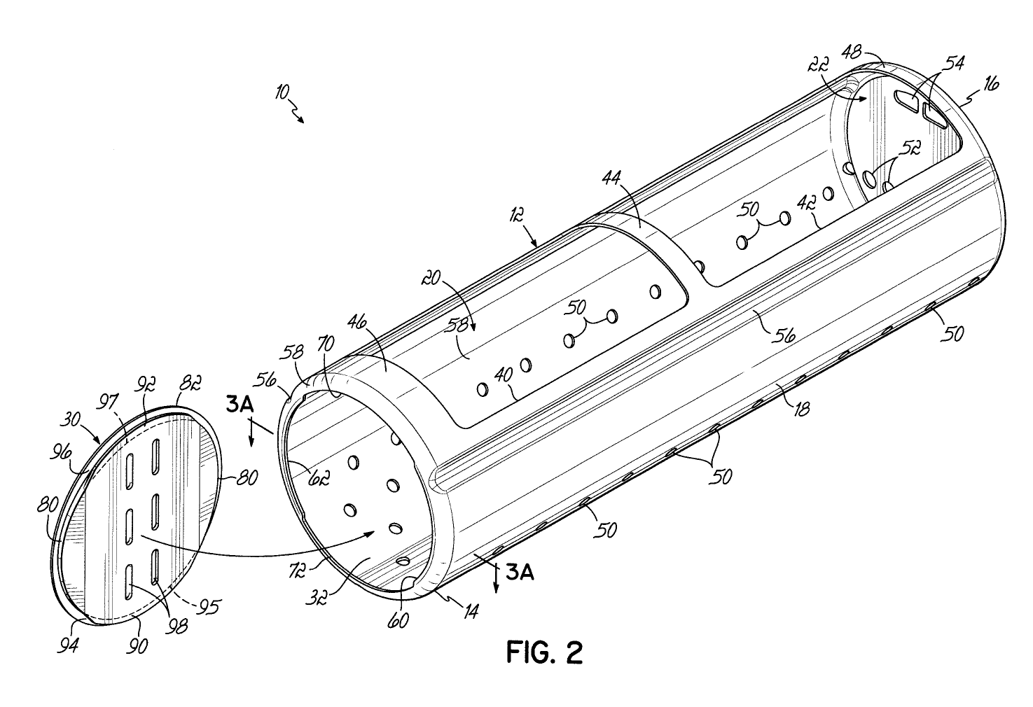

As shown in FIGS. 1 and 2, a load basket 10 for high pressure processing includes a generally cylindrical body 12 having first and second ends 14, 16 and a sidewall 18 extending therebetween. The cylindrical body 12 may be constructed of any material suitable for high pressure processing. While the body 12 is illustrated with a generally cylindrical shape with a generally circular cross-section, the body 12 could have different cross-sectional forms such as square, rectangular, triangular, or any other suitable polygonal shape. As shown, the cylindrical body 12 defines an interior space 20 for receiving packaged food product and a pressure-transmitting fluid of a high pressure processing chamber (not shown). In the embodiment shown, a fixed end cover 22 is permanently attached to the cylindrical body 12 at the second end 16. Alternatively, the cylindrical body 12 and end cover 22 could be formed as a unitary piece. As set forth in further detail below, a removable end cap 30 is selectively attached to the cylindrical body 12 at the first end 14 to at least partially cover an opening 32 thereof. To that end, the end cap 30 may be attached to the cylindrical body 12 by positioning the end cap 30 at or adjacent the opening 32 and rotating the end cap 30 in place. For example, the end cap 30 and first end 14 may be formed with interlocking features such that when the end cap 30 is rotated in place adjacent the opening 32, the interlocking features engage each other to retain the end cap 30 over the opening 32. The interlocking features may be of a low profile so as to avoid interfering with the packaged food product. In this manner, the removable end cap 30 may be selectively attachable to the cylindrical body 12 without a need for barriers, protruding features, or other obstructions that may catch, hook, gouge, or otherwise damage packaged food product during loading, processing, or unloading. Thus, the removable end cap 30 may allow loading, transporting, and/or unloading of packaged food product in various orientations of the basket 10 including horizontal, inclined, and vertical orientations, resulting in expedited food product processing while avoiding unwanted damage to the food product. The features of the load basket 10 are set forth in further detail below to clarify each of these functional advantages and other benefits provided in this disclosure.

With continued reference to FIGS. 1 and 2, the basket 10 may include at least one top opening in the sidewall 18 of the cylindrical body 12, such as first and second top openings 40, 42, through which the packaged food products may be inserted into and removed from the basket 10. As such, the packaged food products may be loaded and/or unloaded via the top openings 40, 42 and/or via the opening 32, depending on the particular application. For example, the packaged food products may be loaded via the top openings 40, 42, such as with the basket 10 in a horizontal orientation and the end cap 30 attached to the first end 14 to cover the opening 32. The packaged food products may be subsequently unloaded via the opening 32 with the end cap 30 removed therefrom, such as with the basket 10 in a vertical or inclined orientation wherein the opening 32 is relatively lower than the second end 16 in order to allow gravity to assist in unloading the packaged food products from the interior space 20. As shown, the first and second top openings 40, 42 are separated by a middle bridging portion 44 of the sidewall 18, which may be used to provide a gripping point for lifting the basket 10. The first and second top openings 40, 42 may terminate at or near the first and second ends 14, 16, respectively. In the embodiment shown, first and second outer bridging portions 46, 48 of the sidewall 18 are provided adjacent the first and second top openings 40, 42, respectively, to assist in maintaining the generally cylindrical shape of the cylindrical body 12, and/or to provide stiffness or rigidity to the cylindrical body 12. As shown, the widths of the first and second outer bridging portions 46, 48 may be different from each other. For example, the width of the first outer bridging portion 46 may be relatively large in order to provide sufficient stiffness and/or rigidity to the cylindrical body 12 at or near the first end 14 to compensate for a lack of material at opening 32 when the end cap 30 is removed, while the width of the second outer bridging portion 48 may be relatively small such that the cylindrical body 12 at or near the second end 16 may rely at least in part on the fixed end cover 22 for stiffness and/or rigidity. Thus, the first outer bridging portion 46 may be considered a reinforcing portion. In one embodiment, at least one of the bridging portions 44, 46, 48 may be used as a gripping point(s) for lifting or otherwise manipulating the cylindrical body 12. In another embodiment, one or both of the top openings 40, 42 may be eliminated.

A plurality of fluid passage holes 50 are provided through the sidewall 18 of the cylindrical body 12 to allow the pressure-transmitting fluid of the high pressure processing chamber to fill the interior space 20 before and/or during processing. In addition or alternatively, the fluid passage holes 50 may allow the pressure-transmitting fluid to drain out of the interior space 20 during and/or after processing. While the fluid passage holes 50 are shown as being positioned in a bottom portion of the cylindrical body 12, it will be appreciated that the fluid passage holes 50 may be positioned at any suitable location, and in any suitable quantity. Alternatively, the fluid passage holes 50 may be eliminated. For example, in certain applications such as seafood applications, it may be desirable to eliminate the fluid passage holes 50 such that the pressure-transmitting fluid may only enter through the top openings 40, 42.

In addition or alternatively, auxiliary fluid passage holes 52 may be provided in at least one of the first or second ends 14, 16 of the cylindrical body 12. For example, as shown, auxiliary fluid passage holes 52 may be provided through the fixed end cover 22 at the second end 16 of the cylindrical body 12. The fixed end cover 22 may also include handle apertures 54 to provide gripping points for carrying or otherwise moving the basket 10. Such handle apertures 54 may also assist in filling and/or draining the interior space 20. As shown, a plurality of longitudinal indentations 56 may extend along an exterior surface of the sidewall 18 between the first and second ends 14, 16, and may provide the basket 10 with increased stiffness and/or rigidity.

With specific reference now to FIG. 2, the end cap 30 and first end 14 may be formed with interlocking features such that when the end cap 30 is rotated in place at or adjacent the opening 32, the interlocking features engage each other to retain the end cap 30 over the opening 32. As shown, the first end 14 includes a rim portion 58 having first and second locking lips 60, 62 and first and second recesses 70, 72 which together define the periphery of the opening 32. In addition to the functions and characteristics of the locking lips 60, 62 and recesses 70, 72 described below, the rim portion 58 provides stiffness and/or rigidity to the first end 14 of the cylindrical body 12 to maintain the cross sectional shape of the cylindrical body 12. As shown, the rim portion 58 may be defined, at least in part, by a radius. It will be appreciated that the radius may vary from that shown. For example, the radius may be decreased such that the rim portion 58 may be smaller than that shown in the illustrated embodiment, so as to increase a diameter of the opening 32.

The removable end cap 30 includes a central portion or hub 80, an outer flange 82, and first and second engagement tabs 90, 92 extending radially outward from the central portion 80. As shown, the first engagement tab 90 and outer flange 82 are spaced apart to define a first channel 94 having a first base surface 95, and the second engagement tab 92 and outer flange 82 are spaced apart to define a second channel 96 having a second base surface 97. The first and second base surfaces 95, 97 may each have a radius of curvature concentric with the central portion 80, and may be congruent with an outer, generally disc-shaped surface of the central portion 80. The first and second recesses 70, 72 are sized to receive the first and second engagement tabs 90, 92, respectively, when the end cap 30 is positioned at or adjacent the opening 32 in a first orientation. Each of the first and second channels 94, 96 are sized to receive either of the first or second locking lips 60, 62 when the end cap 30 is rotated in place from the first orientation into a second orientation. In this manner, the first and second locking lips 60, 62 engage with the engagement tabs 90, 92, outer flange 82, and/or channels 94, 96 in order to retain the end cap 30 over the opening 32.

As shown, the outer flange 82 of the end cap 30 has a cross sectional dimension equal to or greater than a maximum cross sectional dimension of the opening 32, such that the end cap 30 covers the entire opening 32. Nevertheless, the end cap 30 may include a plurality of handle apertures 98 to provide gripping points on the end cap 30 and/or to assist in filling and/or draining of the interior space 20, such that the end cap 30 may only partially cover the opening 32. In addition or alternatively, fluid passage holes similar to those previously discussed may be provided in the end cap 30. In one embodiment, the end cap 30 may include a handle portion 100 for assisting in gripping and/or rotating the end cap 30 as discussed below. The end cap 30 may be constructed of any material suitable for a high pressure processing application. In one embodiment, the end cap 30 and the cylindrical body 12 may be constructed of the same or a similar material.

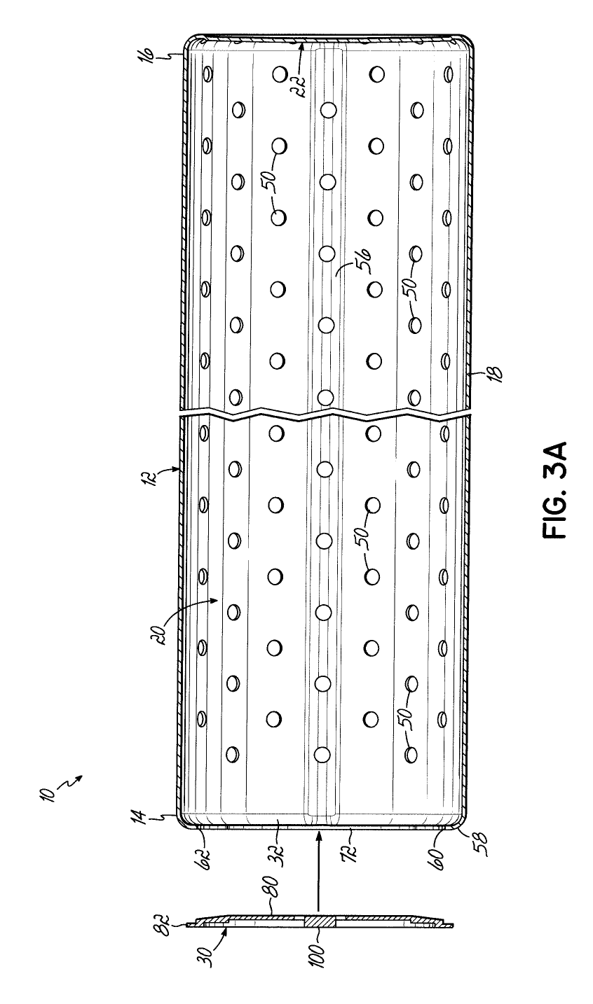

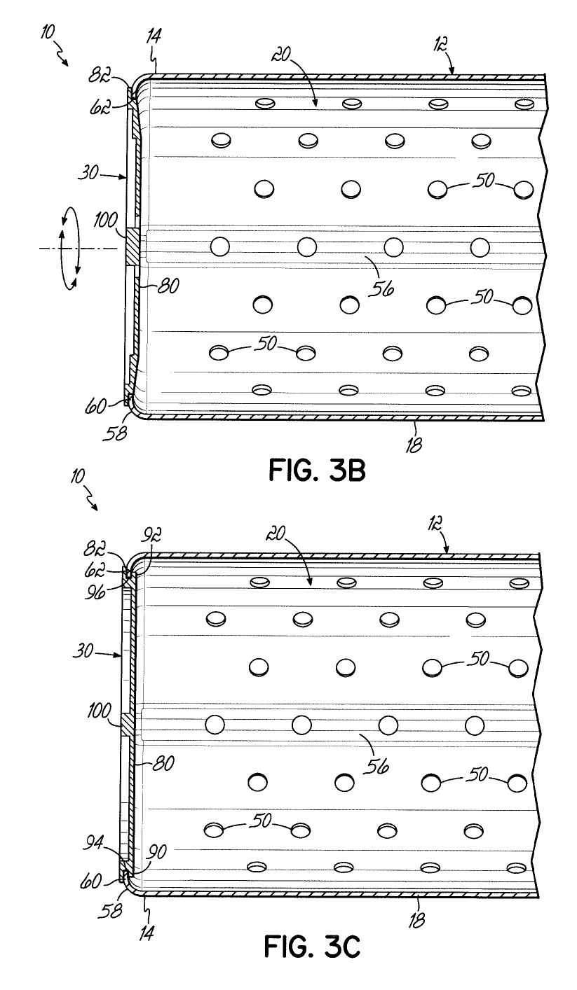

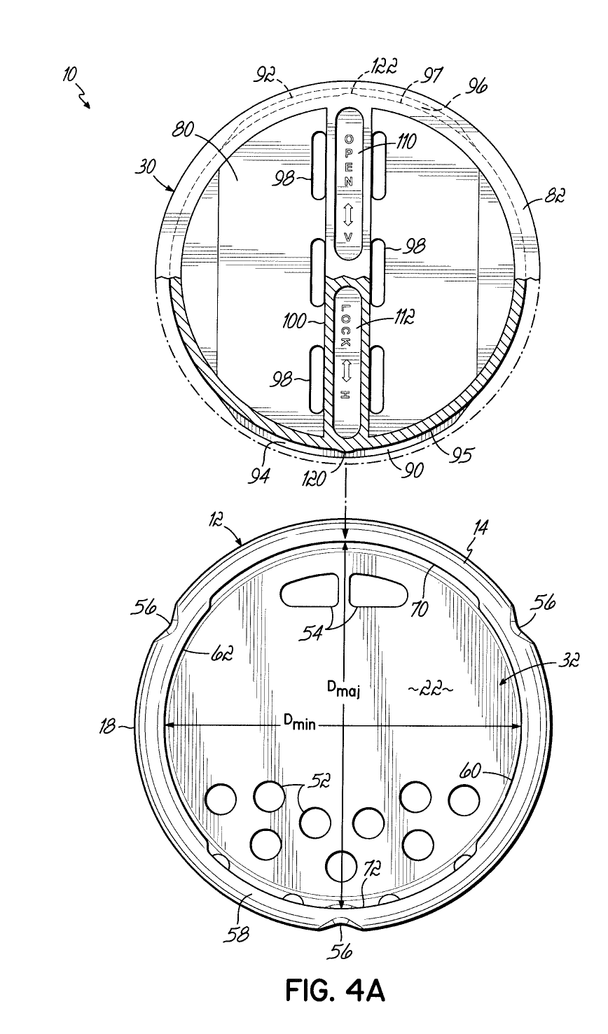

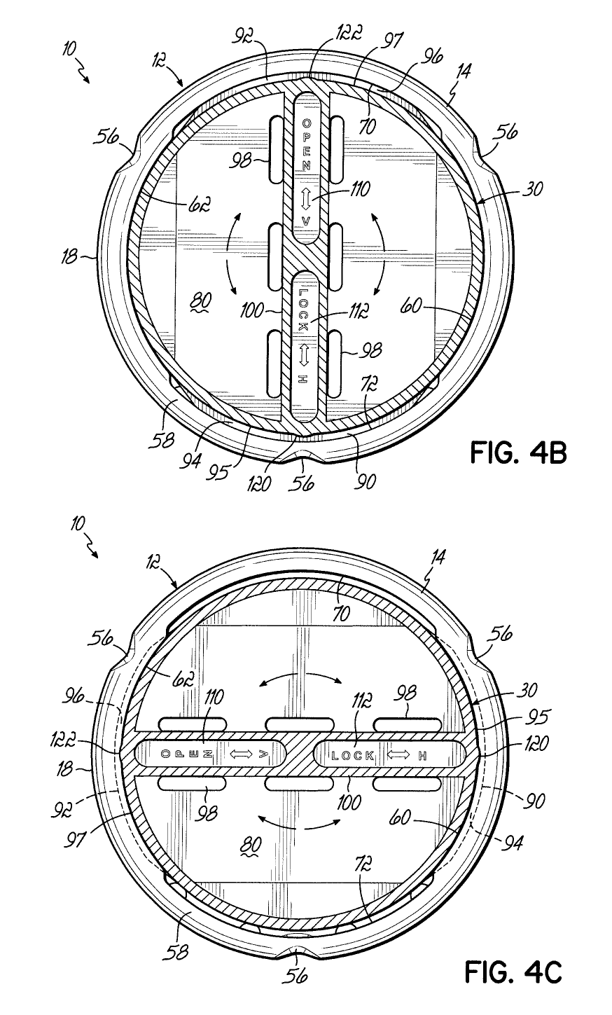

A method of removably attaching the end cap 30 to the cylindrical body 12 will now be described with reference to FIGS. 3A-3C and 4A-4C. Initially, as shown in FIG. 3A, the end cap 30 and the cylindrical body 12 are substantially axially aligned. The removable end cap 30 is oriented in a first orientation relative to the cylindrical body 12, wherein the engagement tabs 90, 92 of the end cap 30 are aligned with the recesses 70, 72 of the first end 14 (FIGS. 3A and 4A). The end cap 30 is then positioned at or adjacent the opening 32, such that the engagement tabs 90, 92 are received within the recesses 70, 72, respectively (FIGS. 3B and 4B). In this position, which may be referred to as an unlocked position, the outer flange 82 of the end cap 30 abuts the first end 14 of the cylindrical body 12 and thus provides an indication that the end cap 30 is properly positioned along a longitudinal axis of the cylindrical body 12. The end cap 30 may then be twisted or rotated in place (e.g. about an axis of the end cap 30), as indicated by the arrows, from the first orientation to a second orientation relative to the cylindrical body 12, wherein the locking lips 60, 62 of the first end 14 are received within the channels 94, 96, respectively, of the end cap 30 (FIGS. 3C and 4C). Rotation of the end cap 30 may be performed by a user manually gripping the handle portion 100 and/or handle apertures 98, and thus may not require any tools. In this position, which may be referred to as a locked position, the locking lips 60, 62 are sandwiched between the outer flange 82 and the respective engagement tab 90, 92. In this manner, the end cap 30 cannot be pulled away from the first end 14, and friction between the outer flange 82, locking lips 60, 62, and engagement tabs 90, 92 keeps the end cap 30 from being unintentionally rotated away from the locked position.

In one embodiment, dimensions of the channels 94, 96 may generally correspond to dimensions of the locking lips 60, 62, such that the end cap 30 may be securely retained over the opening 32 without substantial movement and/or vibrating of the end cap 30 during loading, unloading, transportation or processing. For example, the widths of the channels 94, 96 may be approximately equal to the thicknesses of the locking lips 60, 62 (FIG. 3C), the depths of the channels 94, 96 may be approximately equal to the widths of the locking lips 60, 62 such that the base surfaces 95, 97 may frictionally engage the locking lips 60, 62 (FIG. 3C), and the arc lengths of the channels 94, 96 (via the arc lengths of the respective engagement tabs 90, 92) may be approximately equal to the arc lengths of the locking lips 60, 62 such that engagement may occur over substantially their entire lengths (FIG. 4C).

In the illustrated embodiment, as best shown in FIG. 2, the widths of the channels 94, 96 are substantially uniform along their entire lengths. Alternatively, the width of one or more of the channels 94, 96 may vary. For example, the channels 94, 96 may each include a first width at a first end of the channel 94, 96 and a second width at a second end of the channel 94, 96 that is less than the first width. In other words, the channels 94, 96 may narrow from the first ends to the second ends. This may be achieved, for example, by gradually increasing the material thicknesses of the engagement tabs 90, 92 and/or the outer flange 82 in directions toward the respective channels 94, 96. In one embodiment, the first widths may be approximately equal to the thickness of the locking lips 60, 62, and the second widths may be substantially less than the thickness of the locking lips 60, 62. In this manner, the end cap 30 may only be substantially rotated from the unlocked position in a first direction (e.g. clockwise or counterclockwise), since only the first ends of the channels 94, 96 may be sufficiently wide to receive a leading end of an adjacent locking lip 60, 62. In addition, the narrowing of the channels 94, 96 may allow portions of the outer flange 82 and/or the engagement tabs 90, 92 to exert a clamping force on the respective locking lips 60, 62 as the locking lips 60, 62 are sandwiched therebetween during rotation of the end cap 30 in the first direction. Such clamping forces may improve retention of the end cap 30 at the first end 14 in a locked position. In one embodiment, the channels 94, 96 may become sufficiently narrow toward the second ends to eventually prevent further rotation of the end cap 30 in the first direction.

In another embodiment, the channels 94, 96 may each include a first width at the first and second ends of the channel 94, 96 and a second width at an intermediate point between the first and second ends that is less than the first width. In other words, the channels 94, 96 may narrow from each of the first and second ends to the intermediate point. Similar to the previous embodiment, the first widths may be approximately equal to the thickness of the locking lips 60, 62, and the second widths may be substantially less than the thickness of the locking lips 60, 62, and the narrowing of the channels 94, 96 may allow portions of the outer flange 82 and/or the engagement tabs 90, 92 to exert a clamping force on the respective locking lips 60, 62 as the locking lips 60, 62 are sandwiched therebetween during rotation of the end cap 30. Unlike the previous embodiment, however, the end cap 30 may be rotated from the unlocked position in either direction, since both the first and second ends of the channels 94, 96 may be sufficiently wide to receive a leading end of an adjacent locking lip 60, 62.

As best shown in FIG. 4A, the widths of the locking lips 60, 62 may be relatively small such that the locking lips 60, 62 may extend radially inwardly relative to the recesses 70, 72 a small amount, in order to avoid obstructing and/or damaging packaged food product being passed through the opening 32. In other words, the locking lips 60, 62 may define a minor diameter Dₘᵢₙ of the opening 32 which may be smaller than a major diameter Dₘₐⱼ of the opening 32 defined by the recesses 70, 72 by a small amount. For example, the locking lips 60, 62 may be of a width greater than 0 inches and less than or equal to approximately 6 inches. In one embodiment, the locking lips 60, 62 may be of a width greater than 0 inches and less than or equal to approximately 5 inches. In one embodiment, the locking lips 60, 62 may be of a width greater than 0 inches and less than or equal to approximately 4 inches. In one embodiment, the locking lips 60, 62 may be of a width greater than 0 inches and less than or equal to approximately 3 inches. In one embodiment, the locking lips 60, 62 may be of a width greater than 0 inches and less than or equal to approximately 2 inches. In one embodiment, the locking lips 60, 62 may be of a width greater than 0 inches and less than or equal to approximately 1½ inches. In one embodiment, the locking lips 60, 62 may be of a width between approximately 1/16 of an inch and approximately 2 inches. Thus, the locking lips 60, 62 may be of a low profile which may be, for example, a machined profile.

As best shown in FIGS. 3B and 3C, the central portion 80 and engagement tabs 90, 92 of the end cap 30 include smooth surface(s) facing the interior space 20 when the end cap 30 covers the opening 32, in order to avoid obstructing and/or damaging packaged food product positioned in the interior space 20.

In addition or alternatively, when the load basket 10 is filled with food product the end cap 30 may be retained in a locked position by the force(s) acting on the end cap 30 by the packaged food products. In particular, the packaged food products may exert a force on the end cap 30 in a direction away from the cylindrical body 12, such that the engagement tabs 90, 92 are pressed against the locking lips 60, 62 to prevent the end cap 30 from becoming dislodged from the first end 14.

Once the end cap 30 has been secured over the opening 32 and the basket 10 has been loaded with packaged food product, the basket 10 may be placed into the chamber for processing. In some applications, the basket 10 may be pushed into the chamber by a mechanical manipulator of a material handling system. For example, the manipulator may exert a force on the end cap 30 in a direction toward the cylindrical body 12. In this case, the outer flange 82 may be pressed against the locking lips 60, 62 to transfer the force to the cylindrical body 12 and thereby advance the basket 10 into the chamber.

In order to remove the end cap 30 from the opening 32, the end cap 30 is rotated from a locked position to an unlocked position. In particular, sufficient rotational force is applied to the end cap 30 to overcome any opposing friction between aspects of the end cap 30 and aspects of the cylindrical body 12, and the end cap 30 is rotated relative to the cylindrical body 12 such that the locking lips 60, 62 are no longer received within the channels 94, 96 of the end cap 30 (FIGS. 3B and 4B). As a result, the engagement tabs 90, 92 are received within the recesses 70, 72 such that the end cap 30 may be removed from the opening 32 and pulled away from the cylindrical body 12 to thereby uncover the opening 32 and allow access to the interior space 20 therethrough.

With specific reference to FIGS. 4A-4C, various indicia may be provided on the end cap 30 and/or cylindrical body 12 for indicating whether the end cap 30 is in an unlocked or locked position. For example, the end cap 30 may include open indicia 110 for indicating that the end cap 30 is in an open or unlocked position and may be removed by pulling the end cap 30 away from the cylindrical body 12 to uncover the opening 32 (FIG. 4B). In the embodiment shown, when the end cap 30 is in an open or unlocked position, the open indicia 110 is oriented vertically with respect to the cylindrical body 12. In addition or alternatively, the end cap 30 may include lock indicia 112 indicating that the end cap 30 is in a locked position and may be securely retained over the opening 32 (FIG. 4C). In the embodiment shown, when the end cap 30 is in a locked position, the lock indicia 112 is oriented horizontally with respect to the cylindrical body 12. Thus, a user may readily identify whether the end cap 30 is in a locked or unlocked position. However, it will be appreciated that any other suitable indicia for indicating a locked or unlocked position of the end cap 30 may be used.

While one embodiment may rely on friction between the outer flange 82, locking lips 60, 62, and engagement tabs 90, 92 to retain the end cap 30 in a locked position, an additional mechanical engagement may be provided between the end cap 30 and the cylindrical body 12 for this purpose. For example, first and second detents 120, 122 may extend from an outer surface of the end cap 30 such as, for example, the base surfaces of the channels 94, 96, respectively for frictionally engaging the locking lips 60, 62 in a locked position of the end cap 30. To that end, as best shown in FIG. 4C, the locking lips 60, 62 may be constructed of a semi-flexible or semi-resilient material such that the detents 120, 122 may deform the locking lips 60, 62 sufficiently to grip the locking lips 60, 62 so as to resist rotation of the end cap 30 relative to the cylindrical body 12. While two detents 120, 122 are shown, any number of detents may be provided. In another embodiment, indents (not shown) corresponding to detents 120, 122 may be provided along the locking lips 60, 62 for mating with the detents 120, 122 in a locked position of the end cap 30. In addition or alternatively, a knob or latch (not shown) may be provided on one of the end cap 30 or cylindrical body 12, and a corresponding groove or slot (not shown) may be provided on the other of the end cap 30 or cylindrical body 12. The knob or latch may be inserted into the groove or slot when the end cap 30 is in a locked position to prevent rotation of the end cap 30 away from the locked position. Various other configurations of locking and/or latching mechanisms may be used to facilitate a mechanical engagement between the end cap 30 and the cylindrical body 12 for preventing accidental rotation of the end cap 30 away from a locked position.

As shown in FIGS. 4B and 4C, the arc lengths of each of the engagement tabs 90, 92 and locking lips 60, 62 may be sized such that the end cap 30 need only be rotated a minimal degree in order for leading portions of the first and second locking lips 60, 62 to enter the first and second channels 94, 96, respectively. In one embodiment, the engagement between the outer flange 82, locking lips 60, 62, and engagement tabs 90, 92 may begin substantially immediately upon rotation of the end cap 30. Thus, while the open and lock indicia 110, 112 described above may suggest a 90 degree rotation from an unlocked position to a locked position, it will be appreciated that a rotation of a lesser or greater degree may result in sufficient engagement between the outer flange 82, locking lips 60, 62, and engagement tabs 90, 92 to retain the end cap 30 over the opening 32. In other words, while orienting the end cap 30 in the locked position shown in FIGS. 3C and 4C may provide optimal retention of the end cap 30, various other locked positions may provide sufficient retention for certain applications. Thus, in many cases under-rotating or over-rotating the end cap 30 may be of little or no consequence with respect to retaining the end cap 30 over the opening 32. Alternatively, the arc lengths of each of the engagement tabs 90, 92 and locking lips 60, 62 may be of any suitable size(s). While first and second engagement tabs 90, 92 and first and second locking lips 60, 62 are shown, any suitable number of engagement tabs 90, 92 and locking lips 60, 62 may be used such as, for example three or four of each. In addition or alternatively, the outer flange 82 may be divided into a number of smaller outer flanges corresponding to the number and positions of the engagement tabs so as to allow a corresponding number of locking lips to be sandwiched therebetween. It will be appreciated that a variety of configurations may be used to allow the end cap 30 to be removably coupled to the first end 14 by rotating the end cap 30 in place.

In the embodiment shown in FIGS. 1-4C, the end cap 30 may be rotated in either direction (clockwise or counterclockwise) between locked and unlocked positions. This allows a user to rotate the end cap 30 in any desired manner to achieve a desired orientation of the end cap 30, and allows rapid locking and/or unlocking of the end cap 30 without consideration for the direction of rotation. In another embodiment, positive stops may be provided between the end cap 30 and the cylindrical body 12 to set rotational limits of the end cap 30 relative to the cylindrical body 12. For example, the end cap 30 may be rotatable from an unlocked position to a locked position only in the counterclockwise direction, and likewise may be rotatable from a locked position to an unlocked position only in the clockwise direction, or vice versa.

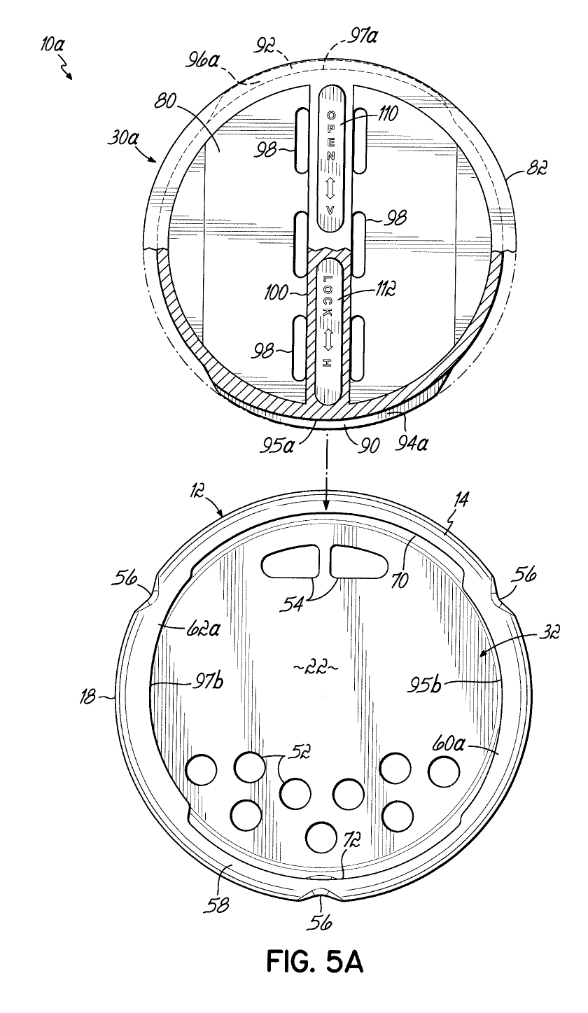

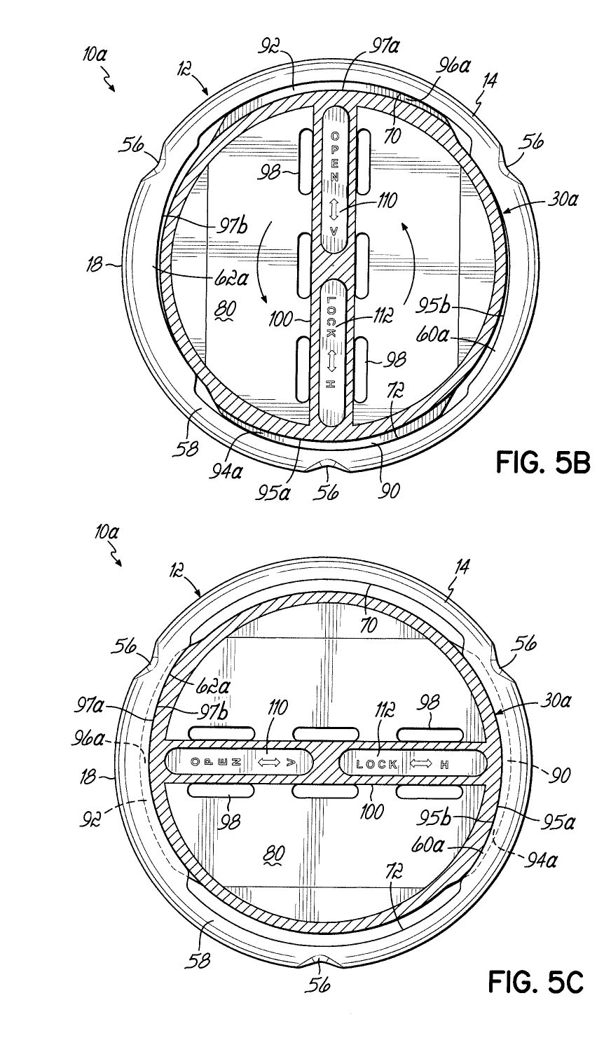

Turning now to FIGS. 5A-5C, wherein like numerals represent like features, in another embodiment, rotational limits of an end cap 30a of a basket 10a may be achieved by varying the widths of the locking lips 60a, 62a in the radial direction and the depths of the channels 94a, 96a along their respective arc lengths in a complementary manner, such that the base surfaces 95a, 97a each have a center of curvature eccentric of the end cap 30 and the locking lips 60a, 62a each have a complementary surface 95b, 97b for abutting the base surfaces 95a, 97a, respectively.

For example, in the embodiment shown the depths of the channels 94a, 96a gradually increase along a counterclockwise path. Thus, the depth of each channel 94a, 96a is relatively small at a first end of the channel 94a, 96a and relatively large at a second end of the channel 94a, 96a counterclockwise relative to the first end. Likewise, the widths of the locking lips 60a, 62a gradually increase along a counterclockwise path in a manner similar to the depths of the respective channels 94a, 96a. Thus, the width of each locking lip 60a, 62a is relatively small at a first end of the locking lip 60a, 62a and relatively large at a second end of the locking lip 60a, 62a counterclockwise relative to the first end. As shown, the relatively small widths of the locking lips 60a, 62a at the first ends of the locking lips 60a, 62a are approximately equal to the relatively small depths of the respective channels 94a, 96a at the first ends of the channels 94a, 96a, and the relatively large widths of the locking lips 60a, 62a at the second ends of the locking lips 60a, 62a are approximately equal to the relatively large depths of the channels 94a, 96a at the second ends of the channels 94a, 96a. In addition, the radius of curvature of each of the base surfaces 95a, 97a of the channels 94a, 96a may be equal to the radius of curvature of the complementary surface 95b, 97b of the respective locking lip 60a, 62a, such that the base surfaces 95a, 97a and complementary surfaces 95b, 97b may mate with each other.

The end cap 30a is rotatable from the unlocked position (FIG. 5B) in the counterclockwise direction such that the locking lips 60a, 62a may be received in the respective channels 94a, 96a as previously described. In this embodiment, as the base surfaces 95a, 97a of the channels 94a, 96a begin to contact the complementary surfaces 95b, 97b of the locking lips 60a, 62a, friction therebetween may resist further rotation of the end cap 30a in the counterclockwise direction. Once the base surfaces 95a, 97a of the channels 94a, 96a substantially abut the respective complementary surfaces 95b, 97b (FIG. 5C), further rotation of the end cap 30a in the counterclockwise direction may be prevented.

As in the previous embodiment, friction between the outer flange 82, locking lips 60a, 62a, and engagement tabs 90, 92 may keep the end cap 30a from being unintentionally rotated away from the locked position. In addition or alternatively, friction between the base surfaces 95a, 97a of the channels 94a, 96a and the complementary surfaces 95b, 97b may keep the end cap 30a from being unintentionally rotated away from the locked position, e.g. in the clockwise direction. In one embodiment, the locking lips 60a, 62a may be constructed of a semi-flexible or semi-resilient material such that the base surfaces 95a, 97a of the channels 94a, 96a may deform the locking lips 60a, 62a as the end cap 30a is rotated toward the locked position in order to tighten the end cap 30a against the first end 14.

In order to remove the end cap 30a from the opening 32, the end cap 30a is rotated from the locked position to the unlocked position. In particular, sufficient rotational force is applied to the end cap 30a to overcome any opposing friction between aspects of the end cap 30 and aspects of the cylindrical body 12 (e.g. between the base surfaces 95a, 97a of the channels 94a, 96a and the complementary surfaces 95b, 97b), and the end cap 30a is rotated clockwise relative to the cylindrical body 12 such that the locking lips 60a, 62a are no longer received within the channels 94a, 96a of the end cap 30a (FIG. 5B). As a result, the engagement tabs 90, 92 are received within the recesses 70, 72 such that the end cap 30a may be removed from the opening 32 and pulled away from the cylindrical body 12 to thereby uncover the opening 32 and allow access to the interior space 20 therethrough.

In the embodiment shown, the end cap 30a is rotatable from a locked position to an unlocked position only in the clockwise direction, due to the interaction between the channels 94a, 96a (e.g. the base surfaces 95a, 97a) and the locking lips 60a, 62a (e.g. the complementary surfaces 95b, 97b). Likewise, the end cap 30a may be rotatable from an unlocked position to a locked position only in the counterclockwise direction. More particularly, the end cap 30a may not be rotatable from the unlocked position (FIG. 5B) in a clockwise direction to a substantial degree because the relatively shallow first ends of the channels 94a, 96a are not sufficiently deep to accept the relatively wide second ends of the respective locking lips 60a, 62a. As a result, portions of the central portion 80 radially inward of the shallow first ends will abut the wide second ends of the locking lips 60a, 62a if an attempt is made to rotate the end cap 30a in the clockwise direction from the unlocked position, thereby preventing such rotation. Alternatively, the varying widths and depths may be reversed (e.g. increased along clockwise paths) such that the end cap 30a may be rotatable from an unlocked position to a locked position only in the clockwise direction, and likewise may be rotatable from a locked position to an unlocked position only in the counterclockwise direction

As shown, open and lock indicia 110, 112 similar to those previously described may be provided on the end cap 30a. In addition or alternatively, indicia such as curved arrows (not shown) indicating the rotational directions to achieve a desired orientation of the end cap 30a may be provided.

While the illustrated embodiments include a removable end cap 30 at the first end 14 and a fixed end cover 22 at the second end 16, other embodiments may include removable end caps at both the first and second ends 14, 16.

While the present invention has been illustrated by a description of various preferred embodiments and while these embodiments have been described in some detail, it is not the intention of the Applicant to restrict or in any way limit the scope of the appended claims to such detail. Additional advantages and modifications will readily appear to those skilled in the art. The various features of the invention may be used alone or in numerous combinations depending on the needs and preferences of the user.

What is claimed is:

1. A basket for high pressure processing, comprising:
a body having first and second ends and a sidewall extending therebetween, wherein the body defines an interior space and the first end includes a first opening for providing access to the interior space; and
a first end cap removably attachable to the body at the first end for at least partially covering the first opening by positioning the first end cap adjacent the first opening and rotating the first end cap in place;
wherein the first end cap and the first end are formed with interlocking features operable to engage each other for attaching the first end cap to the body.

2. The basket of claim 1, wherein the body is generally cylindrical.

3. The basket of claim 1, wherein the interlocking features each have a low profile to minimize obstruction of items passing through the first opening.

4. The basket of claim 1, wherein the first end includes at least first and second locking lips and the first end cap includes at least one outer flange and at least first and second engagement tabs spaced apart from the outer flange to define at least first and second channels for receiving the first and second locking lips.

5. The basket of claim 4, wherein the locking lips frictionally engage at least one of the outer flange or engagement tabs.

6. The basket of claim 4, wherein at least one of the channels has at least one width and at least one of the locking lips has at least one thickness approximately equal to the at least one width.

7. The basket of claim 4, wherein at least one of the channels has at least one depth and at least one of the locking lips has at least one width approximately equal to the at least one depth.

8. The basket of claim 4, wherein at least one of the channels has a first arc length and at least one of the locking lips has a second arc length approximately equal to the first arc length.

9. The basket of claim 4, wherein at least one of the locking lips has a low profile.

10. The basket of claim 9, wherein at least one of the locking lips has a width of between approximately 1/16 of an inch and approximately 2 inches.

11. The basket of claim 1, further comprising a second end cap removably attachable to the body at the second end for at least partially covering a second opening of the second end by positioning the second end cap adjacent the second opening and rotating the second end cap in place.

12. The basket of claim 1, wherein the first end cap includes a plurality of fluid passage holes.

13. The basket of claim 1, further comprising at least one top opening in the sidewall and a reinforcing portion between the first opening and the at least one top opening.

14. A basket for high pressure processing, comprising:
a body having first and second ends and a sidewall extending therebetween, wherein the body defines an interior space and the first end includes a first opening for providing access to the interior space, wherein the first opening is at least partially defined by first and second locking lips and first and second recesses; and
a first end cap including at least one outer flange and at least first and second engagement tabs spaced apart from the at least one outer flange to define at least first and second channels,
wherein the first and second engagement tabs are received in the first and second recesses, respectively, in a first orientation of the first end cap relative to the body, and wherein the first and second locking lips are received in the first and second channels, respectively, in a second orientation of the first end cap relative to the body, such that the first end cap is removable attachable to the body at the first end.

15. The basket of claim 14, wherein the first end cap is rotatable between the first and second orientations in both a clockwise and counterclockwise direction.

16. A method of limiting access to an interior space of a basket for high pressure processing, the basket including a body including first and second ends and a sidewall extending therebetween, the body defining the interior space and the first end including a first opening for providing access to the interior space, the method comprising:
positioning a first end cap adjacent the first opening; and
rotating the first end cap in place to removably attach the first end cap to the body.

17. The method of claim 16, wherein positioning the first end cap adjacent the first opening includes axially aligning the first end cap and the body.

18. The method of claim 16, wherein the first end includes at least first and second locking lips and first and second recesses, and the first end cap includes at least one outer flange and at least first and second engagement tabs spaced apart from the outer flange to define at least first and second channels, wherein positioning the first end cap adjacent the first opening includes positioning the first and second engagement tabs within the first and second recesses, respectively.

19. The method of claim 18, wherein rotating the first end cap in place includes rotating the first end cap from a first orientation wherein the first and second engagement tabs are received in the first and second recesses, respectively, to a second orientation wherein the first and second locking lips are received in the first and second channels, respectively.

20. The method of claim 19, further comprising rotating the first end cap in place from the second orientation to the first orientation.
